(19) United States
(12) Patent Application Publication
(10) Pub. No.: US 2009/0200786 A1
(43) Pub. Date: Aug. 13, 2009

(54) Welded Joint and Method for Forming the Joint

(75) Inventors: Len V. Peschansky, West Bloomfield, MI (US); Paolo V. Sarti, Washington, MI (US); Frank Burger, Ortonville, MI (US); David L. Von Knorring, Oxford, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., DETROIT, MI (US)

(21) Appl. No.: 12/028,880

(22) Filed: Feb. 11, 2008

(51) Int. Cl. F16B 9/02; B62D 21/06; B23K 35/12

(52) U.S. Cl. 280/793; 403/272; 228/256

(57) ABSTRACT

A welded joint includes a cross member, a web having an extruded hole that extends through a thickness of the web and conforms to a cross sectional shape of the cross member, a collar surrounding the hole, formed from material extruded from the web in a direction such that the collar extends along the cross member and away from the web, the cross member extending through the hole and into the collar, and a weld for mutually connecting the collar and the cross member.

### BACKGROUND OF INVENTION

The present invention relates generally to a vehicular chassis, and, more particularly, to joining a cross member to a frame rail, such as a vehicle frame.

The chassis of a motor vehicle includes two laterally spaced, longitudinally directed frame members, on which the suspension, engine and powertrain are supported. The frame rails are in the form of a closed or open section beam having upper and lower flanges or caps, and one or two webs interconnecting the flanges. The frame rails are interconnected by laterally directed cross members, which are secured to the web of each of the frame rails. The cross members are usually cylindrical having a circular or noncircular cross section, which is usually tubular but may be a non-tubular solid, such as a rod. Generally, the frame rails and the cross members are formed of sheet steel.

The cross members may be joined to the web of the frame rails by punching or drilling a hole in the web, inserting the cross member in the hole, and securing the frame rail to the cross member with a weld at the periphery of the hole and cross member. A joint formed in this way has relatively high stress in the weld, which can affect durability.

To enhance durability of the joint, a collar may be welded to the surface of the frame rail surrounding the hole. The cross member is inserted in the hole and through the collar, and the frame rail is secured to the cross member with a weld at the periphery of the collar and the cross member. Although the welded collar provides additional structural continuity between the frame rail and the cross member by adding a third part to the joint, the weld between the collar and frame rail requires additional space, restricting the location of the cross member. The additional collar increases the costs of components, tooling and the welding operation.

A need exists for a joint that provides improved service durability, has a minimum number of parts and requires only a compact space that may extend into a transition radius between the caps and web of the frame rail.

### SUMMARY OF INVENTION

An embodiment contemplates a welded joint for connecting a cross member and a web. The web has an extruded hole that extends through a thickness of the web and conforms to a cross sectional shape of the cross member. A collar surrounding the hole is formed from material extruded from the web in a direction such that the collar extends along the cross member and away from the web. The cross member extends through the hole and into the collar. A weld mutually connects the collar and the cross member.

An advantage of an embodiment is the excellent service durability of a welded joint that incorporates a collar extruded from one of the members connected by the joint. The joint requires no additional component to transition structural load between the joined members, such as a preformed collar. The joint is completed by welding the joined members mutually, thereby eliminating need for a weld between a preformed collar and one of the joined members.

Use of a preformed collar would require additional space to weld the collar to the frame rail. By avoiding the need for a preformed collar, the cross member can be located closer to the tangent of a radius formed between the caps and web of the frame rail.

### BRIEF DESCRIPTION OF DRAWINGS

FIG. 1 is a perspective view of a joint connecting a frame rail and a cross member;

FIG. 2 is a perspective view of the joint shown in FIG. 1 to a larger scale;

FIG. 3 is a cross section through the extruded collar and weld shown in FIG. 1; and

FIG. 4 is a perspective view of a joint connecting a rectangular frame rail and a cross member.

### DETAILED DESCRIPTION

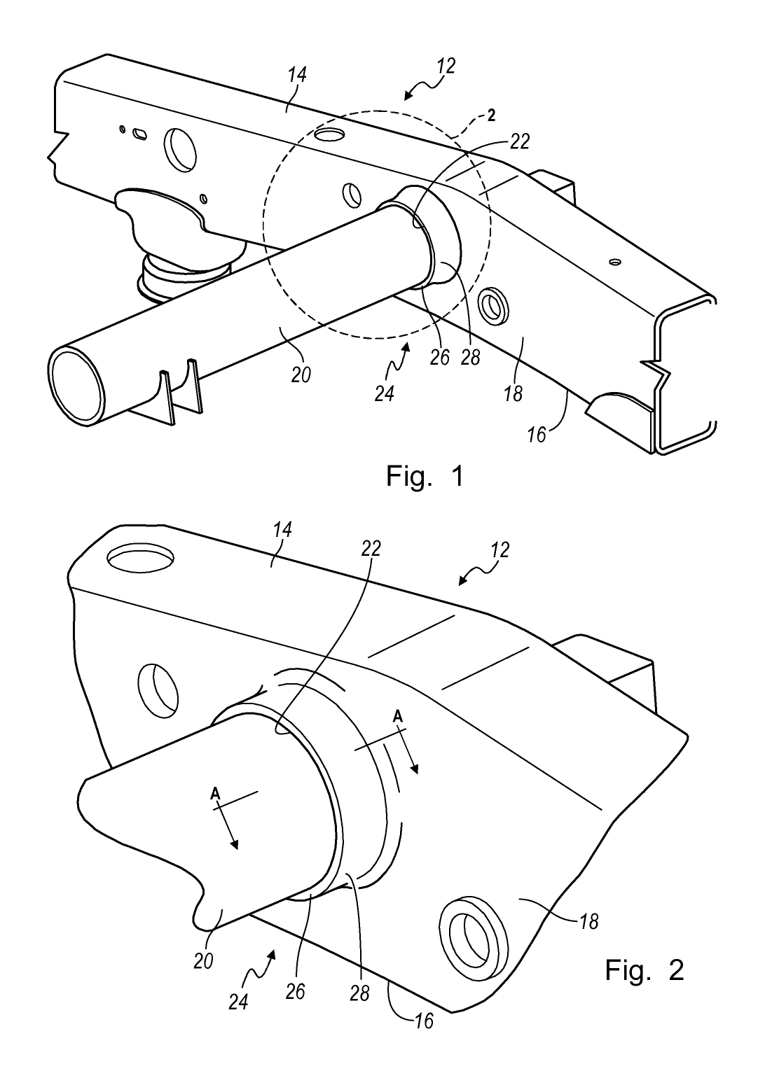

Referring to FIGS. 1 and 2, the frame of a motor vehicle includes two laterally spaced, longitudinally directed frame rails 12, on which the suspension, body, engine and powertrain are supported. The longitudinal frame rails 12 are each in the form of a beam having upper and lower flanges or caps 14, 16 and a web 18 located in a vertical plane and interconnecting the flanges.

The frame rails 12 are interconnected by a laterally directed cross member 20, which is secured to the web 18 of each of the frame rails. The cross member 20 is usually cylindrical having a circular or noncircular cross section, which is usually tubular. Generally, the frame rails 12 and the cross member 20 are formed of low alloy, sheet steel. The cross member 20 extends laterally and substantially perpendicular to the plane of the web 18, or it is inclined with respect to the web.

A joint for connecting the web 18 and cross member 20 includes a hole 22 formed directly in the web. The material of the web 20 is extruded in the direction of the cross member 20, thereby forming an extruded collar or flange 24 that surrounds the hole 22 and extends away from the web. The thickness 26 of the web material surrounding the extruded hole 22 faces the cross member 20.

Referring now to FIG. 3, the extruded collar 24 provides a transitional outer surface 28 that extends a short distance from the web 18 along the length of the cross member 20, and an inner surface that conforms to the shape of the outer surface of cross member 20. A clearance required for assembling and welding, is provided between the outer surface of cross member 20 and the inner surface of the extruded collar 24.

Referring now to FIG. 3, the extruded collar 24 provides a transitional outer surface 28 that extends a short distance from the web 18 along the length of the cross member 20, and an inner surface that conforms to the shape of the outer surface of cross member 20. A clearance required for assembling and welding, is provided between the outer surface of cross member 20 and the inner surface of the extruded collar 24.

After the collar 24 is extruded, the cross member 20 is inserted into the hole 22 and through the extruded collar 24, extending about 10.0 mm. past the collar. Two seam welds 30, 32 secure the extruded collar 24 to the cross member 20. Welds 30, 32 are made using a gas metal arc weld (GMAW), frequently referred to as a MIG weld, which is a commonly used, high deposition rate welding process in which wire is continuously fed from a spool.

The extrusion process for forming hole 22 and collar 24 is described with reference to FIG. 3. After a relatively small centering hole is formed in web 18 at the location of the joint, a tool or die 40, symmetrical about an axis 42, is forced along axis 42 through the hole and web 18, thereby forcing web material surrounding the centering hole radial outward from axis 42 and laterally outward from the plane of the web. The web material conforms to the outer surface of the die, thereby forming the hole 22 and the inner surface of the collar 24. The outer surface of the collar is generally cylindrical with a radius 44 adjacent the web 18.

The extrusion operation improves the material properties in the radius 32 of the extruded collar 24, where typically the highest stress and fatigue damage occurs in this type of joint. Cold working of the extruded collar 24 at the radius 44 improves the strength and durability of the joint.

Without an extrusion collar 24, the highly stressed area of the joint would be in the weld and the heat-affected zone where the web 18 is welded to the cross member 20. That weld would act as a crack initiator as well as a stress concentration, affecting the durability of a joint without an extruded collar 24. A joint having the extruded collar 24 as shown in FIGS. 1-3 places the highly stressed area of the joint in the parent metal of the collar, instead of in the weld.

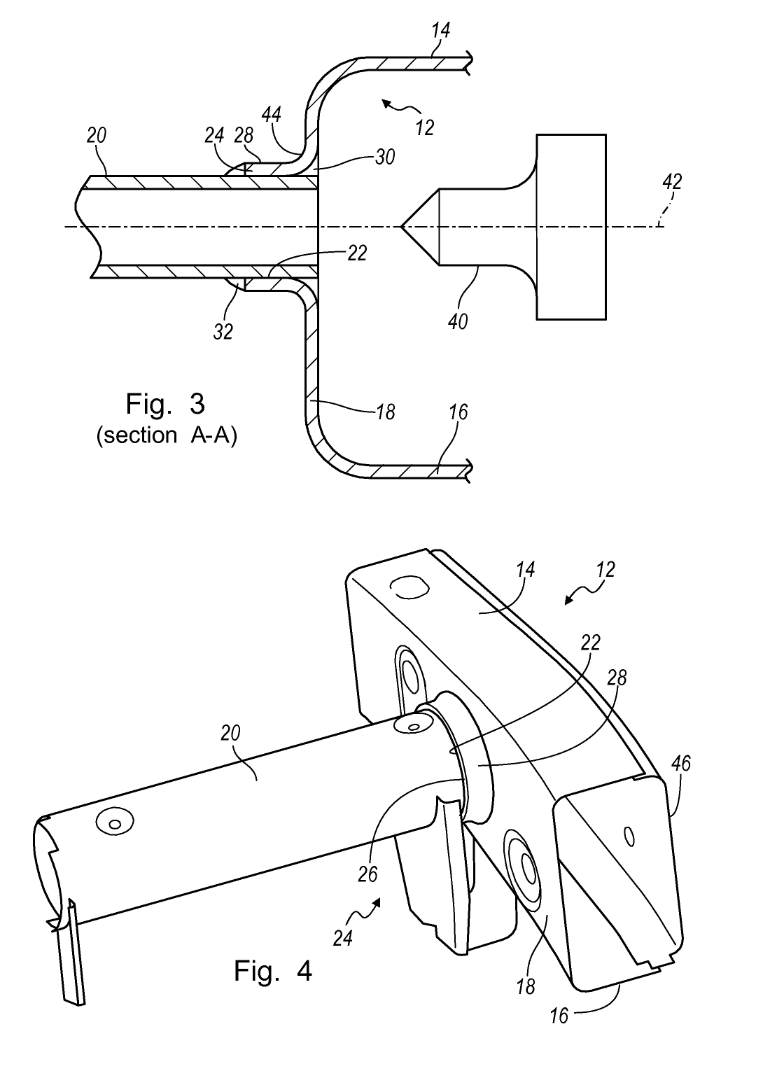

FIG. 4 illustrates a frame rail having a closed rectangular cross section comprising upper and lower caps 14, 16, an inboard web 18 and an outboard web 46, the webs being located in respective vertical planes and interconnecting the caps of the frame rail. The joint 24 is applicable also to a frame rail having a closed, rectangular cross section, as shown in FIG. 4. When the frame rail has a closed cross section, usually the extruded hole 22 and collar 24 are formed in the inboard web 18, and the cross member 20 is welded to the outboard web 46 with a non-extruded hole.

While certain embodiments of the present invention have been described in detail, those familiar with the art to which this invention relates will recognize various alternative designs and embodiments for practicing the invention as defined by the following claims.

What is claimed is:

1. A welded joint for mutually connecting members of a vehicle frame comprising:
a cross member;
a frame rail formed with a hole and a collar surrounding the hole, the collar and the hole being extruded in the frame in a direction such that the collar extends toward the cross member and away from the frame rail, the cross member extending into the collar and through the hole; and
a first weld for mutually connecting the collar and the cross member.

2. The joint of claim 1 wherein the frame rail further comprises:
an upper cap;
a lower cap;
a web that extends in a plane between the upper cap and the lower cap; and
wherein the cross member extends laterally with respect to the plane of the web.

3. The joint of claim 1 wherein the frame rail further comprises:
an upper cap;
a lower cap;
a web located in a plane that extends between the upper cap and the lower cap; and
wherein the hole and collar are formed in the web, and the collar is formed from material extruded from the web.

4. The joint of claim 1 wherein the frame rail further comprises:
an upper cap;
a lower cap;
a web that extends in a plane between the upper cap and the lower cap, and the hole and collar are formed in the web, and the collar is formed from material extruded from the web.

5. The joint of claim 1 further comprising a second weld for mutually connecting the collar and the cross member.

6. The joint of claim 1 wherein:
the cross member extends laterally from a first end of the collar and from a second end of the collar opposite the first end;
the first weld is located at the first end of the collar; and
a second weld is located at the second end of the collar.

7. The joint of claim 1 wherein the cross member is cylindrical, and the weld extends around a periphery of the cross member.

8. The joint of claim 1 wherein the cross member is a circular cylindrical tube, and the weld extends around a circumference of the cross member.

9. A welded joint comprising:
a cylindrical cross member;
a web having an extruded hole that extends through a thickness of the web and conforms to a cross sectional shape of the cross member;
a collar surrounding the hole, formed from material extruded from the web in a direction such that the collar extends along the cross member and away from the web, the cross member extending through the hole and into the collar; and
a first weld for mutually connecting the collar and the cross member.

10. The joint of claim 9 wherein the cross member extends laterally perpendicular to the web.

11. The joint of claim 9 further comprising a second weld for mutually connecting the collar and the cross member.

12. The joint of claim 9 wherein:
the cross member extends laterally from a first end of the collar and from a second end of the collar opposite the first end;
the first weld is located at the first end of the collar; and
a second weld is located at the second end of the collar.

13. The joint of claim 9 wherein the cross member is cylindrical, and the weld extends around a periphery of the cross member.

14. The joint of claim 9 wherein the cross member is a circular cylindrical tube, and the weld extends around a circumference of the cross member.

15. The joint of claim 9 wherein the weld is a seam MIG weld.

16. A method for producing a welded joint for connecting mutually a first member and a second member, comprising the steps of:
(a) extruding a hole through a thickness of the first member that conforms to a cross sectional shape of the second member;
(b) forming a collar by extruding material of the first member surrounding the hole in a direction such that the collar extends along the along the second member and away from the first member;
(c) inserting the second member through the hole and into the collar; and
(d) welding the collar to the second member.

17. The method of claim 16 wherein:
step (a) further comprises forcing a tool though the thickness of the first member to extrude the hole; and
step (b) further comprises forcing a tool through the thickness of the first member to extrude the collar.

18. The method of claim 16 wherein:
step (d) further comprises forming a seam MIG between the collar and the second member.

19. The method of claim 16 wherein:
step (d) further comprises forming a first seam MIG weld between the collar and the second member at a first lateral end of the joint; and
step (d) further comprises forming a second seam MIG weld between the collar and the second member at a second lateral end of the joint opposite the first lateral end.
